(19) United States
(12) Patent Application Publication
(10) Pub. No.: US 2017/0055221 A1
(43) Pub. Date: Feb. 23, 2017

(54) METHOD AND APPARATUS FOR STARTING ENERGY SAVING MODE

(71) Applicant: Xiaomi Inc., Beijing (CN)

(72) Inventors: Enxing HOU, Beijing (CN); Deguo MENG, Beijing (CN); Benchang SU, Beijing (CN)

(73) Assignee: Xiaomi Inc.

(21) Appl. No.: 15/142,003

(22) Filed: Apr. 29, 2016

(30) Foreign Application Priority Data
Aug. 18, 2015 (CN) 201510507481.X

(51) Int. Cl. H04W 52/02

(52) U.S. Cl. CPC H04W 52/0258; H04W 52/0238; H04W 88/16

(57) ABSTRACT

The present disclosure provides a method and an apparatus for starting an energy saving mode. The method includes: acquiring a communication parameter with a gateway device, the communication parameter including at least one of a communication quality parameter or a preset idle period of the apparatus; determining a current running state of the apparatus according to the communication parameter; and starting the energy saving mode for the apparatus when the determined current running state is an idle state.

### CROSS-REFERENCE TO RELATED APPLICATIONS

This application is based on and claims priority to Chinese Patent Application Serial No. 201510507481.X, filed with the State Intellectual Property Office of P. R. China on Aug. 18, 2015, the entire content of which is incorporated herein by reference.

### TECHNICAL FIELD

The present disclosure generally relates to the field of electronic devices, and more particularly, to a method and an apparatus for starting an energy saving mode.

### BACKGROUND

With the development of smart devices such as tablet computers, smart phones, users' demands become higher, and thus more stringent requirements are proposed on the performance of the smart devices. In order to meet the demands of the users, the smart devices are generally configured with relatively high performance.

For example, in order to improve the starting speed of an application, a smart device may start a plurality of applications in the background in advance, such that once the user wishes to open any one of the applications, the smart device opens the interface of the application directly.

### SUMMARY

According to a first aspect of embodiments of the present disclosure, there is provided a method for an apparatus to start an energy saving mode, including: acquiring a communication parameter with a gateway device, the communication parameter including at least one of a communication quality parameter or a preset idle period of the apparatus; determining a current running state of the apparatus according to the communication parameter; and starting the energy saving mode if the determined current running state is an idle state.

According to a second aspect of embodiments of the present disclosure, there is provided an apparatus for starting an energy saving mode, including: a processor; and a memory for storing instructions executable by the processor. The processor is configured to: acquire a communication parameter with a gateway device, the communication parameter including at least one of a communication quality parameter or a preset idle period of the apparatus; determine a current running state of the apparatus according to the communication parameter; and start the energy saving mode if the determined current running state is an idle state.

According to a third aspect of embodiments of the present disclosure, there is provided a non-transitory computer-readable storage medium having stored therein instructions that, when executed by a processor of an apparatus, cause the apparatus to perform a method for starting an energy saving mode. The method includes: acquiring a communication parameter with a gateway device, the communication parameter including at least one of a communication quality parameter or a preset idle period of the apparatus; determining a current running state of the apparatus according to the communication parameter; and starting the energy saving mode if the determined current running state is an idle state.

The solutions provided in embodiments of the present disclosure may have following beneficial effects.

With the method and the apparatus provided by the embodiments of the present disclosure, by acquiring the communication parameter with the gateway device, the energy saving mode is started if it is determined that the current running state is the idle state according to the communication parameter. In this way, under the premise of meeting a user's demand on a performance of a smart device, a power consumption of the smart device is reduced as possible.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for starting an energy saving mode, according to an example embodiment.

FIG. 2 is a flow chart showing a method for starting an energy saving mode, according to an example embodiment.

FIG. 3 is a block diagram of an apparatus for starting an energy saving mode, according to an example embodiment.

FIG. 4 is a block diagram of an apparatus for starting an energy saving mode, according to an example embodiment.

FIG. 5 is a block diagram of an apparatus for starting an energy saving mode, according to an example embodiment.

FIG. 6 is a block diagram of a device for starting an energy saving mode, according to an example embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of methods and devices consistent with aspects related to the invention as recited in the appended claims.

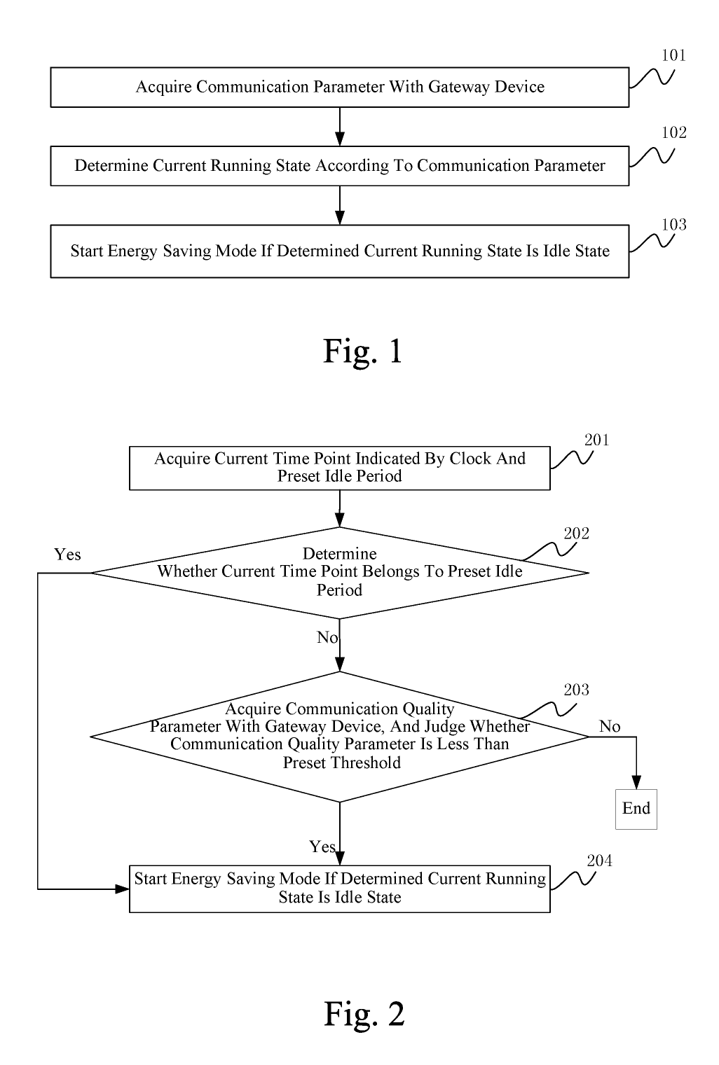

FIG. 1 is a flow chart showing a method for starting an energy saving mode, according to an example embodiment. Referring to FIG. 1, the method for starting an energy saving mode is used in a smart device and includes the following steps.

In step 101, a communication parameter with a gateway device is acquired. The communication parameter includes at least one of a communication quality parameter or a preset idle period of the smart device.

In step 102, a current running state of the smart device is determined according to the communication parameter.

In step 103, the energy saving mode is started for the smart device if the determined current running state is an idle state.

With the method provided by the embodiments of the present disclosure, by acquiring the communication parameter with the gateway device, the energy saving mode is started if it is determined that the current running state is the idle state according to the communication parameter. In this way, under the premise of meeting a user's demand on a performance of the smart device, a power consumption of the smart device is reduced as possible.

In one embodiment, determining a current running state of the smart device according to the communication parameter, includes: acquiring a current time point indicated by a clock; and determining that the current running state is the idle state in response to determining that the current time point belongs to the preset idle period.

In one embodiment, the method further includes: acquiring at least one operating time in a historical operation record, in which the historical operation record is generated according to operation behaviors of a user; and determining the preset idle period according to the at least one operating time.

In one embodiment, starting the energy saving mode includes at least one of reducing a communication frequency with the gateway device; or closing at least one target application already started.

In one embodiment, closing at least one target application already started includes: determining the at least one target application having a priority lower than a preset priority according to a priority of each one of a plurality of applications already started; and closing the at least one target application.

FIG. 2 is a flow chart showing a method for starting an energy saving mode, according to an example embodiment. As shown in FIG. 2, the method for starting an energy saving mode is used in a smart device, and includes following steps.

In step 201, the smart device acquires a current time point indicated by a clock and a preset idle period.

In this embodiment, the smart device may be a smart phone, a smart air conditioner, a smart socket, and a smart bracelet, etc., which is not limited in this embodiment. The smart device may be connected with a gateway device, thereby connecting to a network. The gateway device may be a router, a wireless hotspot, etc. The smart device may be provided with a communication module having a wireless communication function, and is connected with the gateway device via the communication module. The communication module may be a WiFi (Wireless-Fidelity) communication module, a Bluetooth communication module, etc., which is not limited in this embodiment.

During a practical application, the higher the performance of the smart device, the larger its power consumption. If the power consumption of the smart device is overlarge, it may cause an over high temperature and a poor endurance ability, and even influence a normal operation of the smart device. In order to reduce the power consumption of the smart device, the smart device may start the energy saving mode and operate in the energy saving mode.

Further, to reduce the power consumption of the smart device as much as possible under the premise of meeting the user's demand on the performance, the smart device may acquire a communication parameter with a gateway device, determine a current running state according to the communication parameter, and determine whether to start the energy saving mode according to the current running state.

The communication parameter may include at least one of a communication quality parameter or a preset idle period. The smart device may determine the current running state according to the preset idle period.

The preset idle period represents a time period when the smart device is in the idle state, that is, if a current time point is within the preset idle period, it means that the smart device is in the idle state without performing too many operations. The preset idle period may be determined by the smart device in advance, and may be updated during the application process.

For example, the smart device may generate a historical operation record according to operation behaviors of a user on the smart device, and may determine the preset idle period according to the historical operation record.

If the smart device detects that the user operates the smart device, information of the user's operation behavior on the smart device, such as an operating time and an operating type, is acquired and added to the historical operation record. The historical operation record includes at least one operating time. The smart device may acquire the at least one operating time from the historical operation record, perform a statistic on the at least one operating time, and determine a time period with less operations triggered by the user as the preset idle period.

In one embodiment, the smart device may preset a plurality of time periods, determine a time period to which each operating time belongs according to the at least one operating time in the historical operation record, and count the number of operations by the user in each time period. A time period with the smallest number of operations is used as the preset idle period. In one embodiment, a preset number of time periods are selected from the plurality of time periods, according to an ascending order of the number of operations, and the selected time periods are used as the preset idle periods.

For example, by performing a statistic on the operating time of the user, the smart device determines that the user triggers fewest operations from 11 m to 6 am, and thus the time period from 11 pm to 6 am may be set as the preset idle period.

In step 202, the smart device determines whether the current time point belongs to the preset idle period, if yes, the step 204 is executed, and if no, the step 203 is executed.

In this embodiment, in order to determine the current running state of the smart device, the smart device may acquire the current time point indicated by the clock and determine whether the current time point belongs to the preset idle period. If the current time point belongs to the preset idle period, it means that the smart device is in the idle state currently, and step 204 is executed; and if the current time point does not belong to the preset idle period, it means that the smart device may not be in the idle state currently, and step 203 is executed.

In step 203, the smart device acquires a communication quality parameter with a gateway device, and judges whether the communication quality parameter is less than a preset threshold, if yes, the step 204 is executed, and if no, the process ends.

During a practical application, the smart device may also acquire the communication quality parameter between the smart device and the gateway device. The communication quality parameter represents a quality of the communication between the smart device and the gateway device. If the quality of the communication between the smart device and the gateway device is poor, it may be considered that the smart device is in the idle state currently, and it is unnecessary to frequently communicate with the gateway device at this time.

The communication quality parameter may be a signal strength between the smart device and the gateway device. The smart device may detect the signal strength with the gateway device periodically and judge whether the signal strength is less than the preset threshold. If the signal strength is less than the preset threshold, it means that the quality of the communication between the smart device and the gateway device is poor, and it may be determined that the smart device is in the idle state currently. If the signal strength is greater than or equal to the preset threshold, it means that the quality of the communication between the smart device and the gateway device is good, and it may be determined that the smart device is not in the idle state currently.

It should be noted that step 203 is executed after step 202 in FIG. 2. In some embodiments, the smart device may also execute step 202 and step 203 separately. Accordingly, the current running state of the smart device is determined according to any one or both of the preset idle period and the communication quality parameter. In other embodiments, the smart device may merely execute step 203, that is, the current running state is determined according to the communication quality parameter. The way to execute one or both of steps 202 and 203 is not limited in the present disclosure.

In step 204, the smart device starts the energy saving mode if the determined current running state is the idle state.

It is determined that the smart device is in the idle state currently, in response to determining that the current time point belongs to the preset idle period, or in response to determining that the communication quality parameter is less than the preset threshold. If the smart device is currently in the idle state, it means that operations required to be executed by the smart device are fewer, and the user's demand on the performance may be met if the energy saving mode is started. Thus, in order to reduce the power consumption, the smart device may start the energy saving mode.

In one embodiment, to start the energy saving mode, the smart device reduces a communication frequency with the gateway device.

The smart device may reduce the communication frequency with the gateway device according to a preset communication frequency interval, such that a difference between an original communication frequency and a reduced communication frequency is equal to the preset communication frequency interval. Alternatively and/or additionally, the smart device may reduce the communication frequency with the gateway device according to a preset communication frequency, such that the reduced communication frequency is equal to the preset communication frequency.

The preset communication frequency interval and the preset communication frequency may be determined by the smart device in advance according to a communication frequency under general power consumption, which are not limited in this embodiment.

In one embodiment, to start the energy saving mode, the smart device closes at least one target application already started.

During a practical application, the smart device may run at least one application, and the at least one application may include an application software program, a system process, or a system thread etc., which is not limited in this embodiment.

The smart device may set a priority for each application. When starting the energy saving mode, the smart device may determine at least one target application having a priority lower than a preset priority according to the priority of each one of a plurality of applications already started. It may be considered that it is unnecessary for the smart device to run the at least one target application, and the at least one target application may be closed in order to reduce the power consumption of the smart device. The preset priority may be determined by the smart device according to the number of applications under each priority, which is not limited in this embodiment.

For example, priorities of five applications currently started are shown in Table 1 below. If the preset priority is 3, then it is determined that a priority 4 of an application E is lower than the preset priority 3, and thus the application E should be closed.

TABLE 1

| application | priority |
|---|---|
| application A | 1 |
| application B | 2 |
| application C | 2 |
| application D | 3 |
| application E | 4 |

Moreover, the smart device may also employ other manners to run in the energy saving mode, such as reducing a communication frequency of a central processor, or reducing a brightness of a display screen, which is not limited in this embodiment.

In a subsequent process, the smart device may continue to judge whether the current time period belongs to the preset idle period, or to judge whether the communication quality parameter between the smart device and the gateway device is less than the preset threshold, thus determining the current running state. If it is determined that the smart device is in the idle state currently, the smart device continues to run in the energy saving mode, and if it is determined that the smart device is not in the idle state currently, the energy saving mode is shut down so as to run in a normal mode.

With the method provided by the embodiments of the present disclosure, by starting the energy saving mode if it is determined that the smart device is in the idle state currently according to at least one of the communication quality parameter between the smart device and the gateway device and the preset idle period, the power consumption of the smart device is reduced as possible under the premise of meeting the user's demand on the performance of the smart device.

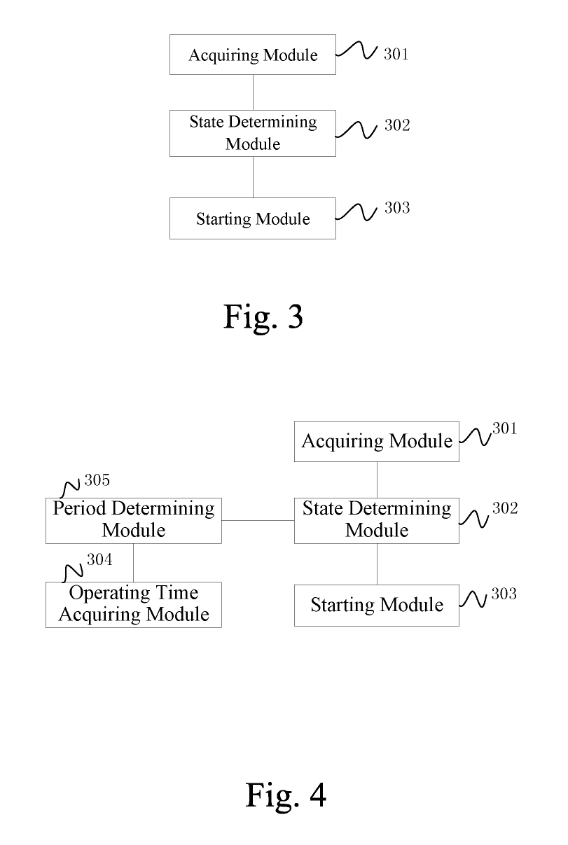

FIG. 3 is a block diagram of an apparatus for starting an energy saving mode, according to an example embodiment. With reference to FIG. 3, the apparatus includes an acquiring module 301, a state determining module 302, and a starting module 303.

The acquiring module 301 is configured to acquire a communication parameter with a gateway device. The communication parameter includes at least one of a communication quality parameter or a preset idle period.

The state determining module 302 is configured to determine a current running state according to the communication parameter acquired by the acquiring module.

The starting module 303 is configured to start the energy saving mode in response to that the state determining module 302 determines that the current running state is an idle state.

With the apparatus provided by the embodiments, by acquiring the communication parameter with the gateway device, the energy saving mode is started in response to determining that the current running state is the idle state. In this way, under the premise of meeting a user's demand on a performance of a smart device, a power consumption of the smart device is reduced as possible.

In one embodiment, the state determining module 302 is further configured to acquire a current time point indicated by a clock; and to determine that the current running state is the idle state in response to determining that the current time point belongs to the preset idle period.

Referring to FIG. 4, in one embodiment, the apparatus further includes: an operating time acquiring module 304 configured to acquire at least one operating time in a historical operation record generated according to operation behaviors of a user; and a period determining module 305 configured to determine the preset idle period according to the at least one operating time.

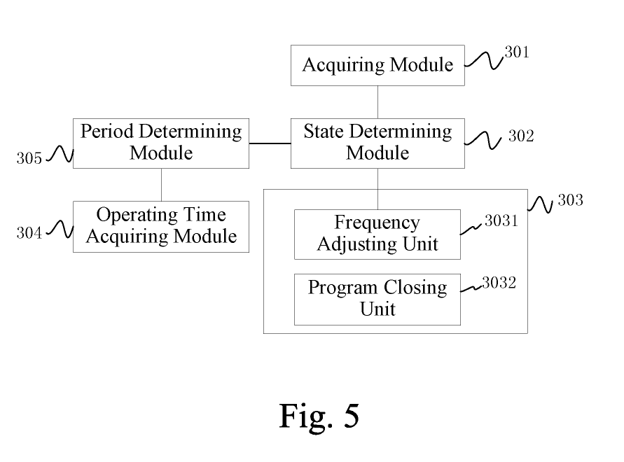

Referring to FIG. 5, in one embodiment, the starting module 303 includes at least one of: a frequency adjusting unit 3031 configured to reduce a communication frequency with the gateway device; or a program closing unit 3032 configured to close at least one target application already started.

In one embodiment, the program closing unit 3032 is further configured to determine the at least one target application having a priority lower than a preset priority according to a priority of each one of a plurality of applications already started; and to close the at least one target application.

With respect to the apparatus in the above embodiments, the specific manners for performing operations for individual modules therein have been described in detail in the embodiments regarding the method, which will not be repeated herein.

It should be noted that, the apparatus for starting an energy saving mode provided by the embodiments above starts the energy saving mode, which is illustrated by a division of respective function modules above. In practical application, the function distribution above may be completed by different function modules in accordance with requirements, that is, an internal structure of the smart device is divided into different function modules to complete all or a part of functions described above. Further, embodiments of the apparatus for starting an energy saving mode and embodiments of the method for starting an energy saving mode belong to a same technical conception, and thus the specific implementation may refer to the embodiments of the method, which will not be repeated herein.

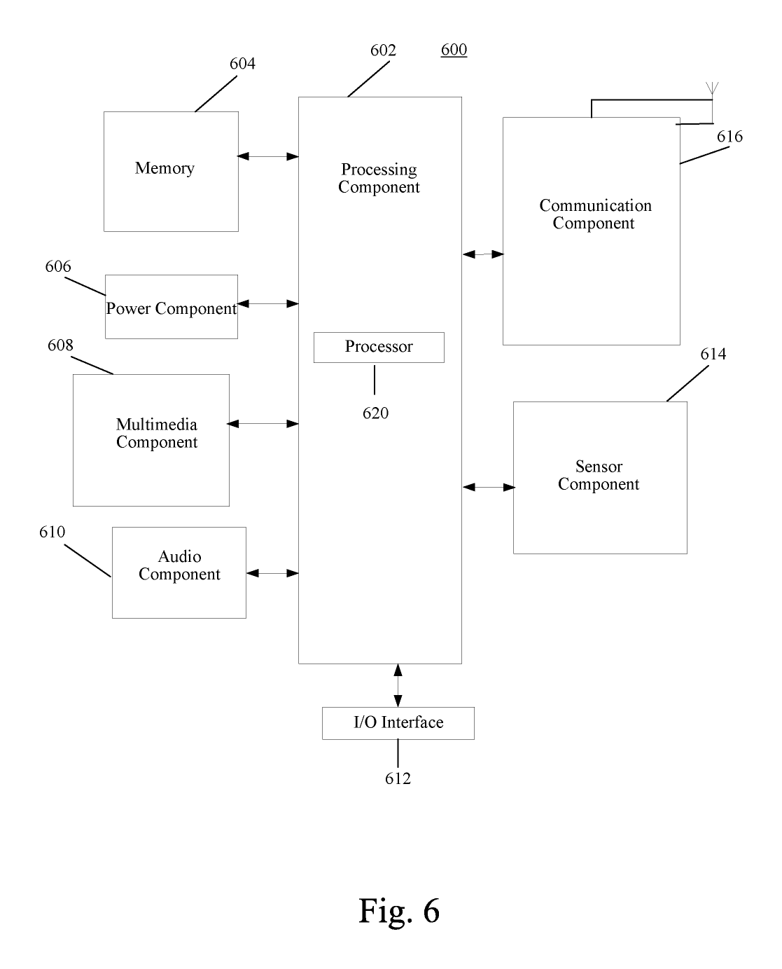

FIG. 6 is a block diagram of a device 600 for starting an energy saving mode, according to an example embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G; or 3G; or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of submodules/subunits.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for an apparatus to start an energy saving mode, comprising:
acquiring a communication parameter with a gateway device, the communication parameter including at least one of a communication quality parameter or a preset idle period of the apparatus;
determining a current running state of the apparatus according to the communication parameter; and
starting the energy saving mode for the apparatus if the determined current running state is an idle state.

2. The method according to claim 1, wherein determining a current running state of the apparatus according to the communication parameter, comprises:
acquiring a current time point indicated by a clock; and
determining that the current running state is the idle state in response to determining that the current time point belongs to the preset idle period.

3. The method according to claim 2, further comprising:
acquiring at least one operating time in a historical operation record of the apparatus, wherein the historical operation record is generated according to operation behaviors of a user of the apparatus; and
determining the preset idle period according to the at least one operating time.

4. The method according to claim 1, wherein starting the energy saving mode comprises at least one of:
reducing a communication frequency with the gateway device; or
closing at least one target application already started.

5. The method according to claim 4, wherein closing at least one target application already started comprises:
determining the at least one target application having a priority lower than a preset priority according to a priority of each one of a plurality of applications already started; and
closing the at least one target application.

6. An apparatus for starting an energy saving mode, comprising:
a processor; and
a memory for storing instructions executable by the processor;
wherein the processor is configured to:
acquire a communication parameter with a gateway device, the communication parameter including at least one of a communication quality parameter or a preset idle period of the apparatus;
determine a current running state of the apparatus according to the communication parameter; and
start the energy saving mode if the determined current running state is an idle state.

7. The apparatus according to claim 6, wherein the processor is further configured to:
acquire a current time point indicated by a clock; and
determine that the current running state is the idle state in response to determining that the current time point belongs to the preset idle period.

8. The apparatus according to claim 7, wherein the processor is further configured to:
acquire at least one operating time in a historical operation record of the apparatus, wherein the historical operation record is generated according to operation behaviors of a user of the apparatus; and
determine the preset idle period according to the at least one operating time.

9. The apparatus according to claim 6, wherein the processor is further configured to start the energy saving mode by at least one of:
reducing a communication frequency with the gateway device; or
closing at least one target application already started.

10. The apparatus according to claim 9, wherein the processor is further configured to close at least one target application already started by:
determining the at least one target application having a priority lower than a preset priority according to a priority of each one of a plurality of applications already started; and
closing the at least one target application.

11. A non-transitory computer-readable storage medium having stored therein instructions that, when executed by a processor of an apparatus, cause the apparatus to perform a method for starting an energy saving mode, the method comprising:
acquiring a communication parameter with a gateway device, the communication parameter including at least one of a communication quality parameter or a preset idle period of the apparatus;
determining a current running state of the apparatus according to the communication parameter; and
starting the energy saving mode for the apparatus if the determined current running state is an idle state.
